(19) United States
(12) Patent Application Publication
(10) Pub. No.: US 2003/0051896 A1
(43) Pub. Date: Mar. 20, 2003

(54) Stretchable suspending, anchoring, or joining sleeve for a bare composite electric conductor

(75) Inventors: Denis Boidard, Saint Entienne (FR); Jean-Francois Murgue, Le Chambon Feugerolles (FR)

Correspondence Address: OLIFF & BERRIDGE, PLC, P.O. BOX 19928, ALEXANDRIA, VA, 22320, US

(73) Assignee: DERVAUX, Le Chambon Feugerolles (FR)

(21) Appl. No.: 10/023,645

(22) Filed: Dec. 21, 2001

Related U.S. Application Data
(60) Provisional application No. 60/270,127, filed on Feb. 22, 2001.

(30) Foreign Application Priority Data
Dec. 22, 2000 (FR) 00.17128

(51) Int. Cl. H02G 15/02; H01R 4/10

(52) U.S. Cl. 174/78; 439/877

(57) ABSTRACT

Stretchable suspending, anchoring, or joining sleeve for a bare composite electric conductor. This sleeve is comprised of a tubular body made of electrically conducting ductile metal alloy provided locally with an outer recess for reception and departure of a stretching ring and with a stretchable part deformation of which, by displacement of ring, ensures shrinking of this part of the body onto the conductor inserted into the axial bore of this body. According to the invention, the recess for reception and departure of stretching ring is located near one of the ends of the tubular body while the stretchable part of the body extends between this recess and an end-of-stretching recess located downstream of the inner end of the fitting area of the conductor in the axial bore of the body to form a chamber in this axial bore when stretching occurs, said chamber receiving the strands with the greatest elongation.

### BACKGROUND OF THE INVENTION

1. Field of Invention

At the present time, electric conductors are suspended under poles or anchored on a support, and the conductors are joined end to end, with compressible or stretchable sleeves comprising an electrically conducting tubular body made of a ductile metal alloy connectable to the conductor by plastic deformation on the latter. In suspending or anchoring sleeves, this tubular body is integral with attaching means and possibly a plate acting as a lead.

2. Description of Related Art

British document GB-A-902,197 describes a first technique for joining a sleeve and conductor consisting of shrinking the tubular body onto a composite conductor using jaws with hexagonal internal profiles, tightened radially onto the conductor by a portable press. This technique does not fully control the radial forces applied to the conductor so that when a composite body is shrunk onto the conductor there are local breaks in the ceramic fibers of the core reducing the resistance of the core to longitudinal tensile stresses applied to it due to the sag and weight of the conductor. Moreover, after tightening, the conductor remains subject to local non-uniform tightening stresses.

Another technique described in EP13655 consists of shrinking the tubular body onto the conductor by stretching using a ring with a frustoconical bore disposed in a recess in the tubular body and displaced lengthwise over a part thereof that has a larger outside diameter than the smallest inside diameter of the ring. While this technique is appropriate for conductors in which the various strand layers and the core have similar elongation ratios, it is inappropriate for composite conductors with ceramic cores in which the elongation ratio of the core is virtually zero by comparison to that of the outside strand layers made of aluminum or aluminum alloy. The reason for this is that, when the tubular body is stretched by displacement of the frustoconical ring, because of the small degree of elongation of the ceramic fibers in the core the aluminum alloy strands subjected to the lengthwise component of the radial tightening force applied by the moving ring are elongated more than the fibers in the core; each fiber forms a loop around this core, and together the fibers form a lump several times the nominal diameter of the cable and known as a bird cage.

### SUMMARY OF THE INVENTION

The invention relates to a stretchable suspending, anchoring, or joining sleeve for a bare composite electric conductor.

To reduce line losses in high-voltage electric lines, it is planned to use so-called “high-temperature” bare conductors made of composite materials and composed for example of a core formed of a complex of aluminum wires mingled with ceramic fibers, made of alumina for example, and peripheral strands made of individual aluminum or aluminum alloy strands.

The goal of the present invention is to provide a stretchable sleeve that can be shrunk onto a composite conductor without its components being damaged and without forming a bird cage.

For this purpose, in the stretchable sleeve according to the invention, the recess for reception and departure of the stretching ring is located near one of the ends of the tubular body, while the stretchable part of the body extends between this recess for reception and departure of the stretching ring and an end-of-stretching recess located downstream of the inner end of the fitting area of the conductor in the axial bore of the body to form a chamber in this axial bore when the stretching occurs in the direction from the starting recess to the end-of-stretching recess, said chamber receiving the conductor strands with the greatest elongation.

Thus, the arrangement of an end-of-stretching recess on the stretching body, beyond the conductor fitting area, allows a chamber to be formed in the bore of the body, in which chamber the strands with the greatest elongation are not subjected to any stress and can move freely without affecting the link between these strands and the tubular body and without forming an unattractive snarl. Moreover, each conductor strand can elongate, according to friction, independently of the elongation of the neighboring strands.

In an embodiment relating to the suspending and anchoring sleeves, the reception and departure recess of the stretching ring is located near the end of the body opposite the end of this same body which is integral with mounting means, while the end-of-stretching recess is located near the end of the body provided with mounting means and above the reception chamber.

It should be noted that, with this anchoring or suspending sleeve, stretching occurs from the free end to the end providing with mounting means, namely the reverse direction to the stretching direction described in document EP-A-13655.

In its application to a joining sleeve, the end-of-stretching recess is disposed near the central part of the tubular body and above a reception chamber provided in the central part of the bore of the tubular body and common to both halves of the body, each of which halves has, near its free end, a recess for reception and departure of a ring, and between this recess and the end-of-stretching recess, a stretchable part, shrinkage of which is effected by moving the corresponding stretching ring in the direction from the starting recess to the end-of-stretching recess.

Once again, the starting and end-of-stretching recesses are disposed such that shrinkage of each half of the sleeve occurs in the direction from the reception chamber to gather the ends of the strands with the greatest elongation in this chamber. The invention will be better understood from the description hereinbelow with reference to the attached schematic drawings showing several embodiments of the sleeve according to the invention as examples.

### BRIEF DESCRIPTION OF THE DRAWINGS

FIGS. 1 and 2 are lengthwise sectional views of a first embodiment of an anchoring sleeve before and after stretching respectively.

FIG. 3 is a lengthwise sectional view of another embodiment of an anchoring sleeve before stretching.

FIG. 4 is a lengthwise sectional view of a joining sleeve half of which is waiting to be slid onto a conductor while the other half has been shrunk onto the conductor.

### DETAILED DESCRIPTION OF PREFERRED EMBODIMENTS

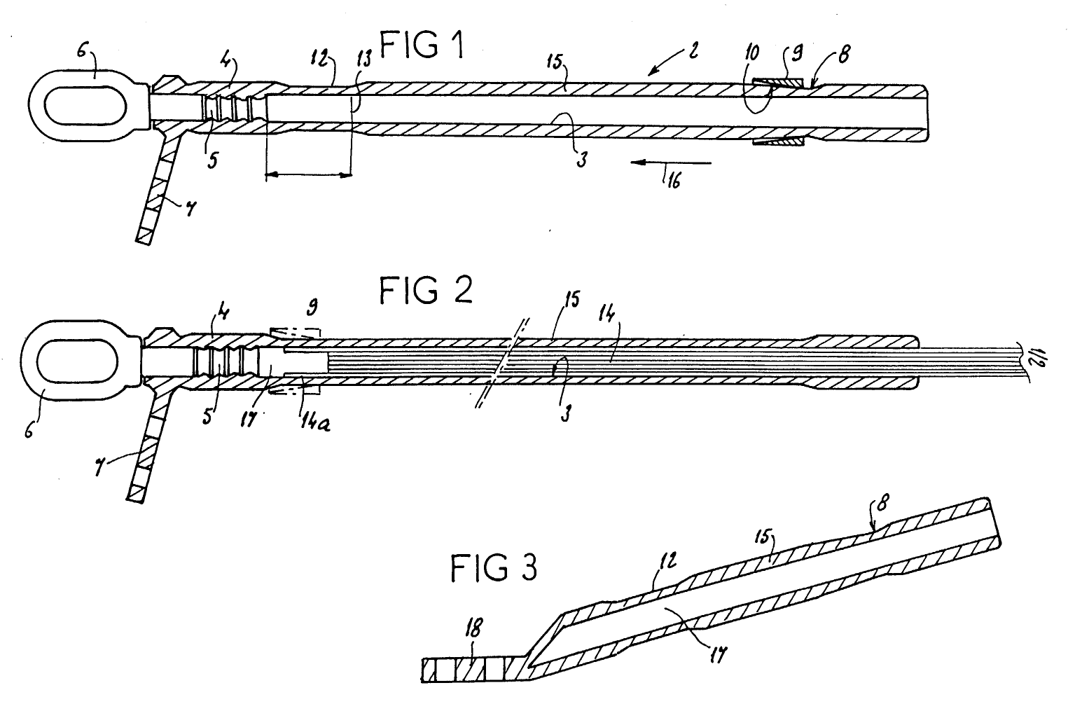

In the embodiment shown in FIGS. 1 and 2 and corresponding to an anchoring sleeve, the sleeve is essentially made of a conducting, tubular body 2 made of metal, for example an aluminum alloy. This body 2 is traversed lengthwise by an axial bore 3. One of the ends of the body is shrunk at 4 onto the crenelated tang 5 of a mounting ring 6. This end is also integral with a plate 7 that acts as a lead.

Near its other end, the body has a recess 8 for reception and departure of a two-part stretching ring 9. This ring has a frustoconical bore whose vertex angle a is less than 15°, for example 8°. Recess 8, which is designed to receive and support both parts of this ring until the sleeve has undergone the stretching operation, is itself frustoconical, but with an even shallower angle to facilitate the beginning of the stretching operation. The tubular body 2 is provided in the vicinity of the end that has mounting means 6, with a flat-bottomed recess 12 whose recess-bottom diameter is less than the smallest diameter of ring 8. This recess, known as the end-of-stretching recess, is disposed substantially at the inside end, indicated by a dashed line 13, of the area where conductor 14 fits into bore 3. In practice, recess 12 is disposed such that it is downstream of the fitting area.

Part 15 of the tubular body disposed between recess 8 and recess 12 is the part that is stretchable and shrinkable onto conductor 14 fitted into bore 3. To ensure the link between body 2 and conductor 14, ring 9 is displaced on part 15 in the direction of arrow 16, namely in the direction from recess 8 to recess 12. This displacement of the ring creates radial forces on the material of which part 15 is composed, which is thus forced between the outer strands of conductor 14, and these strands transmit these radial stresses to the core 11 of the conductor.

In known fashion, the smallest diameter of the ring is chosen such as to apply a stress that is uniform over the entire periphery of part 15 but also over the entire length of this part, and has a sufficient value to shrink this part 15 without damaging the core of the conductor.

Simultaneously, due to the conical shape of bore 10 of ring 9, and also due to the displacement of ring 9, this ring applies lengthwise forces to part 15 which tend to displace the material of which it is composed in the direction of mounting means 6, thereby stretching part 15. These elongation forces are communicated to the outer and inner strands of core 11 of conductor 14, and these strands stretch to a greater or lesser degree depending on their elongation ratio. As shown in FIG. 2, the strands 19 with greater elongation gradually penetrate into a reception chamber 17 formed in bore 3 below recess 12. To improve visualization in the drawings of the differential elongation between the metal strands and the strands with ceramic fibers, the strands are shown parallel to the lengthwise axis of bore 3, even though they are in a helix. The length S of reception chamber 17 is chosen such that, at the end of stretching, namely when ring 9 occupies the position shown in dashed lines in FIG. 2, the strands with the greatest elongation are fully contained in chamber 17 without coming in contact with any stopping means.

Because of this arrangement, each of the strands of the conductor moves freely according to its elongation ratio and the forces to which it is subjected and, because of the orientation of this elongation in the direction of chamber 17, cannot participate in formation of a bird cage, namely an unattractive lump on the outside that causes technical problems.

After the stretching process, two-part ring 9 is removed.

It emerges from the foregoing that the sleeve according to the invention enables the desired radial stress for holding the conductor to be produced by stretching with no risk of damaging the ceramic fibers of the core, while avoiding the consequences of the elongation differential between the components of the composite conductor.

The embodiment shown in FIG. 3 differs from the preceding embodiment by the fact that the mounting means are formed not of a ring 6 but of a plate 18 integral with tubular body 2. Apart from this difference, the anchoring sleeve is similar in all respects to the previous anchoring sleeve because, like the former, it has a recess 8 for reception and departure of stretching ring 9, a stretchable part 15, an end-of-stretching recess 12, and a chamber 17 for receiving the conductor strands with the greatest elongation.

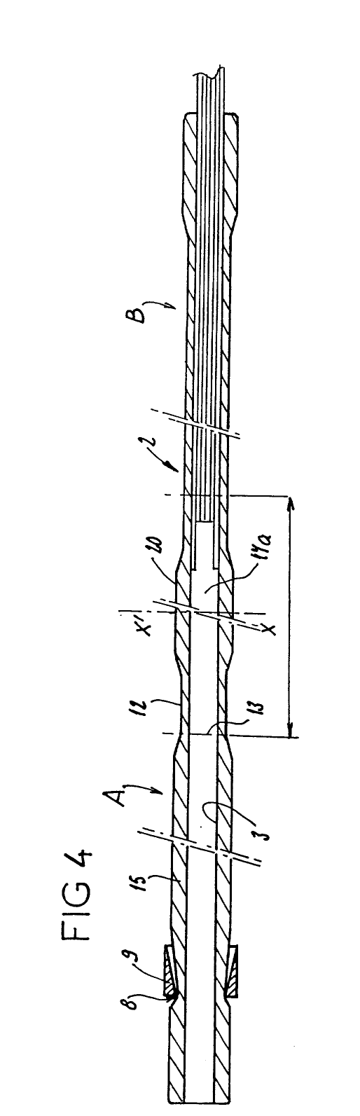

FIG. 4 shows a joining sleeve composed of two identical halves A and B disposed symmetrically relative to a transverse axis x′x. As in the previous embodiments, each half has a recess 8a for reception and departure of a stretching ring 9, a stretchable part 15a, and an end-of-stretching recess 12a disposed downstream of the inner end 13a of the area where the conductor fits into the corresponding half A or B of the tubular body 2.

Relative to the previous embodiments, the axial bore 3a is continuous over the entire length of the sleeve and hence passes from the free end of half A to the free end of half B, passing through a central holder 20 to hold the sleeve while it is being stretched.

In FIG. 4, half A is shown in the position in which it is waiting for a conductor to be fitted, while half B is shown after stretching, conductor 14 being shrunk by tubular body 2a. In this joining sleeve, reception chamber 17a is common to both halves of the sleeve and thus extends over a length Sa on either side of the central part of this sleeve.

As in the foregoing embodiments, shrinkage occurs by successively moving stretching rings 9a from the free end to the center of the sleeve and achieves the same results, namely an acceptable radial stress on the conductor, particularly on its core, is achieved while any bird cage formation at either end of the joining sleeve is prevented.

The use of stretching rings thus has the advantage of preventing parts 15a from bending, so there is no risk of the sleeve becoming banana-shaped.

What is claimed is:

1. Stretchable suspending, anchoring, or joining sleeve for a bare composite electric conductor having a tubular body made of an electrically conducting ductile metal alloy integral or non-integral with mounting means to a support, said body being provided locally with an outer recess forming a reception and departure area of a stretching ring with a frustoconical bore and a stretchable part with a larger diameter than the small inside diameter of ring, deformation of which, by displacement of ring, ensures shrinking of this part of the body onto the conductor inserted into the axial bore of this body, characterized in that the recess for reception and departure of stretching ring is located near one of the ends of the tubular body while the stretchable part of body extends between this recess for reception and departure of stretching ring and an end-of-stretching recess located downstream of the inner end of the fitting area of conductor in the axial bore of body to form a chamber in this axial bore when the stretching occurs in the direction from the starting recess to the end-of-stretching recess, said chamber receiving the conductor strands with the greatest elongation.

2. Anchoring and suspending sleeve according to claim 1, characterized in that the reception and departure recess of stretching ring is located near the end of the body opposite the end of this same body which is integral with mounting means, while the end-of-stretching recess is located near the end of the body provided with mounting means downstream of the reception chamber.

3. Joining sleeve according to claim 1, characterized in that the end-of-stretching recess is disposed near the central part of tubular body and above a reception chamber provided in the central part of bore of the tubular body and common to both halves of the body, each of which halves has, near its free end, a recess for reception and departure of a ring, and between this recess and end-of-stretching recess, a stretchable part, shrinkage of which is effected by the movement of the corresponding stretching ring in the direction from the starting recess to the end-of-stretching recess.
